(19) United States
(12) Patent Application Publication
(10) Pub. No.: US 2023/0360009 A1
(43) Pub. Date: Nov. 9, 2023

(54) DATA-PROCESSING SYSTEM AND INTEGRATION OF PAYMENT MEANS OPERATIONS

(71) Applicant: First Tech Tecnologia Ltda., Sao Paulo (BR)

(72) Inventor: Gustavo Eduardo ASSUNÇÃO DA SILVEIRA, Sao Paulo (BR)

(21) Appl. No.: 18/143,874

(22) Filed: May 5, 2023

(30) Foreign Application Priority Data
May 6, 2022 (BR) BR 102022008797-0

(51) Int. Cl. G06Q 20/10; G06Q 20/38

(52) U.S. Cl. CPC G06Q 20/102; G06Q 20/3823

(57) ABSTRACT

What is described is a data-processing system and integration of payment means operations (100) comprising:
an equipment and services platform (50);
multiple sources of payment means operations (30a, 30b, 30c, 30d);
data processer of payment means operations,
the equipment and services platform (50) receiving multiple data and transactions (3a, 3b, 3c, 3d) from the multiple sources of payment means operations (30a, 30b, 30c, 30d), said multiple data and transactions (3a, 3b, 3c, 3d) being identified and processed individually by the data processer of payment means operations such that each of the multiple sources of payment means operation (30a, 30b, 30c, 30d) receives specific responses (3′a, 3′b, 3′c, 3′d) for their operations.

### FIELD

The present invention refers to a data-processing system, particularly used in the integration of payment means operations originating from multiple sources. This data-processing system makes use of a computer program to identify the transactions of each of the multiple sources, process them and reply to each requesting source with security.

### CROSS REFERENCE

The present application claims priority benefit of Brazilian application no. BR 10 2022 008797.0, filed May 6, 2022, the entire content of which is incorporated herein by reference.

### DESCRIPTION OF THE STATE OF THE ART

Companies that make use of digital payment means, such as payments by way of cards, digital remittances, and others, need to guarantee security in the data-processing of this type of transaction and comply with the requirements and determinations for certificates like the PCI (Payment Card Industry).

This is because compliance with PCI security requirements is a condition for companies involved in payment systems to be able to operate, besides guaranteeing protection of the different users of these means such as, for example, companies, banks and end clients.

To satisfy the requirements of PCI security and be able to operate with payment means, companies such as Fintechs, digital banks, traditional banks and others, currently need to have their own infrastructure of equipment, processes, certifications of environments and monitoring that guarantee data processing and security in these payment transactions.

In this sense, these companies comprise their own processing system, endowed with a structure which relies on data receipt by means of applications in a cloud environment, processing these data to obtain authorization of the payment transaction, as a rule coming from credit card operators for example, and equipment to provide processing of the transactions guaranteeing the security of the data involved in the payment operations.

Specifically in relation to this security of the data involved in the transactions or payment operations, these companies need to make use of a cryptograph that consists of a hardware-based encryption device known as HSM. This is a physical device that provides security for the storage of cryptographic keys, that is, this device carries, among other things, various codes, security procedures, transaction routines and robust cryptographic algorithms, recommended by the PCI, which prevent confidential data from being accessed by unauthorized agents as its security module has inviolable and self-destructive resources that are activated in cases of attempted invasion, causing the loss of the information stored therein.

However, it comes at a high cost for this infrastructure of data-processing and security devices to satisfy the recommendations of the PCI, since the equipment needed has a high purchase and maintenance cost and, further, requires steps of certifications, personnel training, monitoring etc., making the total ownership cost extremely high, and this may affect the quality of the service offered by these companies.

More specifically, this type of infrastructure requires: equipment, datacenter and systems, adjustment for PCI certificates, high investment in the purchase of HSMs, infrastructure for the key ceremony (procedure that requires the physical presence of various persons and has extremely high security rules for creating keys and cryptographic components), time to implement and embed the applications and HSM pursuant to PCI requirements, in addition to a specialized team with knowledge of all this technology.

Therefore, the structure of this type of project known and available today has become inaccessible and highly expensive for most companies that need to use payment means for their business, and for companies that sell payment services and solutions.

### OBJECTIVES OF THE INVENTION

Therefore, the objective of the present invention is to provide a processing system and integration of payment means operations capable of enabling multiple sources to make use of the infrastructure of equipment and security certifications to process their volume of transactions according to their specific needs.

It is also an objective of this invention to provide a data-processing system and integration of payment means operations that makes use of a computer program to identify the transactions of each of the multiple sources received, process them in the same infrastructure of equipment and security certifications and respond to the requesting source with security and meet the volume required of each of the multiple sources.

### BRIEF DESCRIPTION OF THE INVENTION

Accordingly, the object of the present invention is a data-processing system and integration of payment means operations comprising
an equipment and services platform;
multiple sources of payment means operations;
data processer of payment means operations,
the equipment and services platform receiving multiple data and transactions from the multiple sources of payment means operations, said multiple data and transactions being identified and processed individually by the data processer of payment means operations such that each of the multiple sources of payment means operation receives specific responses for their operations.

### BRIEF DESCRIPTION OF THE DRAWINGS

FIG. 1—is a schematic illustration of an example of the multiple sources of payment means that make up the data-processing system and integration of payment means operations, object of this invention;

FIG. 2—is a schematic illustration of the equipment and services platform comprised within the data-processing system and integration of payment means operations, object of the present invention; and

FIG. 3—is a schematic illustration of the data-processing system and integration of payment means operations, object of the present invention.

### DETAILED DESCRIPTION OF THE INVENTION

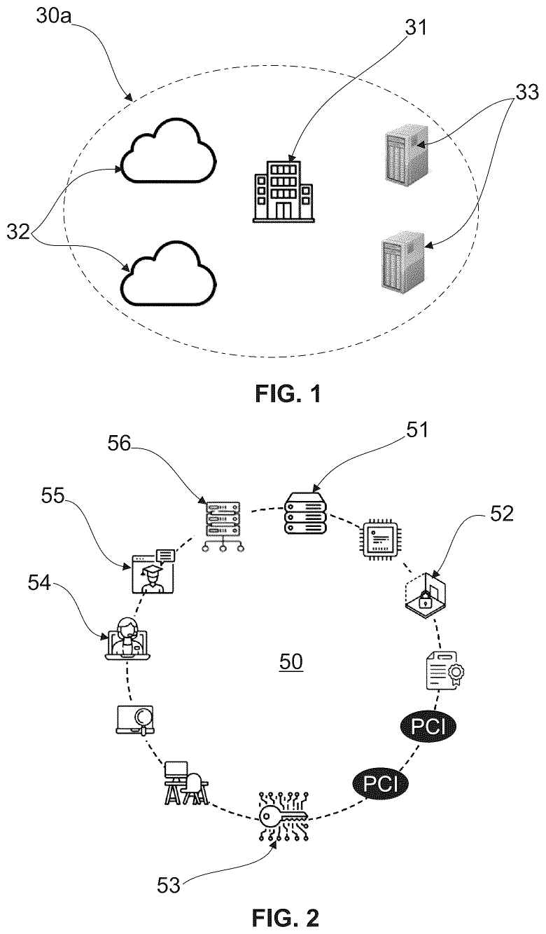

According to a preferred embodiment and as illustrated in FIGS. 1 to 3, the data-processing system and integration of payment means operations 100, object of the present invention, comprises an equipment and services platform 50, multiple sources of payment means operations 30a, 30b, 30c, 30d and a data processer of payment means operations which is a computer program embedded in the equipment and services platform 50.

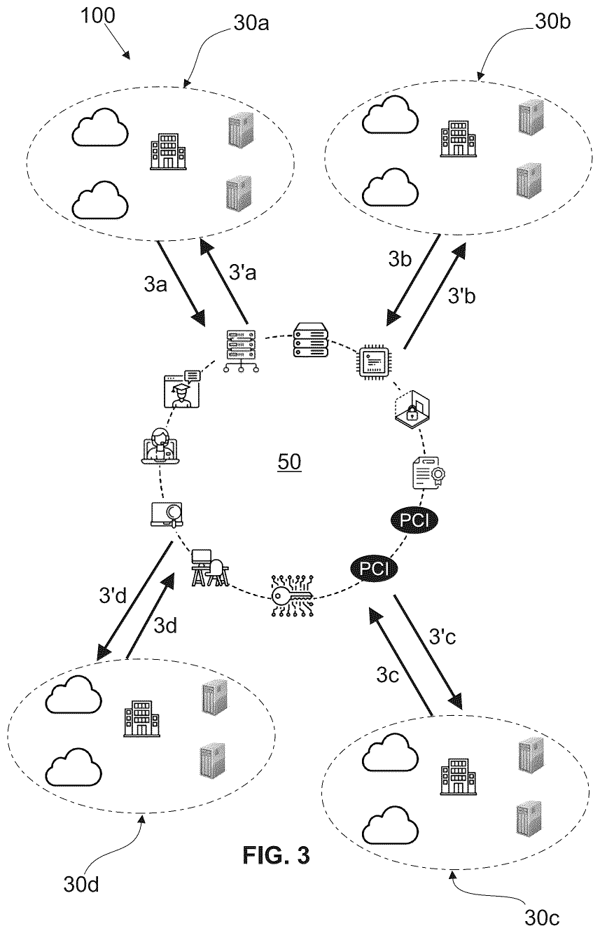

As illustrated in FIGS. 1 and 3, the multiple sources of payment means operations 30a, 30b, 30c, 30d consist of users 31 that can be companies of different types such as Fintechs, banks, sales companies, service providers, and others, or else individuals. These users receive orders from clients 32 via applications or systems in cloud environments, these orders are met resulting in a transaction or payment order. The users 31 perform initial processing of this transaction or payment order by means of processing hubs 33 which may be, for example, credit card hubs of clients 32, with the aim of obtaining authorization for the transaction.

Once authorization for the transaction is obtained, latter turns into data and transaction 3a, 3b, 3c, 3d which are transmitted to the equipment and services platform 50.

In this sense and as can be seen in FIG. 3, the equipment and services platform 50 receives multiple data and transactions 3a, 3b, 3c, 3d from the multiple sources of payment means operations 30a, 30b, 30c, 30d which are connected to this equipment and services platform 50.

When received on the equipment and services platform 50, the multiple data and transactions 3a, 3b, 3c, 3d are identified and processed, individually, by the data processer of payment means operations. More specifically, the data processer of payment means operations, which is a computer program, receives and identifies the multiple data and transactions 3a, 3b, 3c, 3d, individually processes the transactions on the equipment and services platform 50 and returns the specific responses 3′a, 3′b, 3′c, 3′d to the multiple sources of payment means operations 30a, 30b, 30c, 30d, such that each of the multiple sources of payment means operation 30a, 30b, 30c, 30d receives specific responses 3′a, 3′b, 3′c, 3′d for their operations.

In addition to the data processer of payment means operations, the equipment and services platform 50 comprises a technological infrastructure of equipment and services harmonized with the recommendations of PCI security and certified by the PCI for processing data and transactions 3a, 3b, 3c, 3d.

In this sense, to guarantee security in the receipt and processing of the data and transactions 3a, 3b, 3c, 3d, and in the delivery of responses 3′a, 3′b, 3′c, 3′d, the equipment and services platform 50 comprises, as illustrated in FIG. 2, environments such as the Safe Room 52 where various operations occur with cryptographic keys and the key ceremony Module 53 in which there is the physical presence of specialized professionals to input information and monitor the generation, storage, issuance and management of the symmetric and a symmetric-keys and cryptographic components used to handle the data and transactions 3a, 3b, 3c, 3d and also the responses 3′a, 3′b, 3′c, 3′d inside the platform 50 environment. Additionally, there is the Support of specialist professionals 54 and trained team 55 for performing the functions and protocols, so as to render the data-processing and transactions 3a, 3b, 3c, 3d operation the most efficient and safest payment means pursuant to the protocols required for these operations.

The processing of the data and transactions 3a, 3b, 3c, 3d in itself occurs on the equipment and services platform 50, in a Data-processing Center 56 or Data Center, Tier 3, where the data processer of payment means operations is executed so as to make the reading of the multiple data and processing of the multiple transactions received from the multiple sources 30a, 30b, 30c, 30d.

This processing has at least a hardware-based encryption device 51 or HSM.

The HSM, equipped with its master key, delimits a cryptographic domain. This cryptographic domain protects transactional elements like cryptographic keys, payment card passwords and their numbers. The system 100 provides the logical and cryptographic isolation of the multiple sources 30a, 30b, 30c, 30d using the equipment and services platform 50 through specific configurations of the HSM 51, management of the cryptographic keys, management of sessions, management of access and credentials.

To-date, this equipment has been used individually by organizations that are part of the transactional line. Acquirers, flags, banks and processors, in isolation, used to manage the physical and logical components of the HSMs.

The system 100 provides the entire framework needed and required by the norms and best market practices to enable clients, that is, multiple sources 30a, 30b, 30c, 30d, to outsource their infrastructures.

Therefore, with this logical and cryptographic isolation each datum and transaction of the multiple data and transactions 3a, 3b, 3c, 3d are received by the platform 50, are processed and, through the HSM 51, the multiple sources 30a, 30b, 30c, 30d, receive the specific responses 3′a, 3′b, 3′c, 3′d for their operations. All this processing occurs in a cloud environment, guaranteeing the multiple sources 30a, 30b, 30c, 30d easy access to the system 100.

Preferably, the hardware-based encryption device 51 or HSM used on the platform 50 is a payShield 10K Thales. However, other types of HSM can be used provided the expected functionality is maintained. Additionally, embedded in the platform 50, the system 100 has PCI and FIPS-3 certifications, API services (REST API and ISO 8583), technical support 24-hours per day, seven days a week, all year round in order to guarantee the operation, stability and high availability of the entire business operation, as well as data monitoring that enables the generation of metrics and billing.

The volume of data-processing and transactions 3a, 3b, 3c, 3d received by the platform 50 may vary from one source of payment means operation 30a, 30b, 30c, 30d to another and, further, the volume of data-processing of a given source of payment means operation 30a, 30b, 30c, 30d may increase depending on the time of the year or due to an increase in sales or services and business prosperity. In all these situations, the system 100 is flexible to meet, by way of the platform 50 and the data processer, alterations in demands from the multiple sources of payment means operation 30a, 30b, 30c, 30d, that is, the volume of processing of transactions is scalable according to the need of the source 30a, 30b, 30c, 30d.

Consequently, by means of this architecture, the data-processing system and integration of payment means operations 100 allows various companies or multiple sources of payment means operations 30a, 30b, 30c, 30d to make shared use of the same equipment and services platform 50 to process their data of payment means operations, such that this processing will be performed in accordance with PCI security protocols, by means of sophisticated technology equipment and in a fully certified and monitored environment, with up-to-date firmwares and, mainly, so that the results of their transactions will be made available in a secure and specific way for their businesses. Put otherwise, the use of the system 100 can be shared by the multiple sources 30a, 30b, 30c, 30d, but the handling of the data, processing of the transactions and delivery of the results is carried out specifically and individually for each of these multiple sources 30a, 30b, 30c, 30d.

Accordingly, the source of payment means operations 30a, 30b, 30c, 30d (Fintechs, Digital Banks and payment companies, for example) does not need to acquire the equipment and upkeep the entire infrastructure of the platform 50, assure certifications, train professionals or increase the personnel framework, perform monitoring etc. The sources of operations 30a, 30b, 30c, 30d can use, on a shared basis, the data-processing system and integration of payment means operations 100 which will be responsible for guaranteeing safe processing at a lower cost.

Further in relation to the data-processing system and integration of payment means operations 100, object of this invention, it is important to emphasize that the equipment of the platform 50 can be allocated in the structure of the client or of the source 30a, 30b, 30c, 30d, at a remote structure of a provider of this service or, further, in both places.

Having described an example of a preferred embodiment, it should be understood that the scope of the present invention encompasses other possible variations, being limited solely by the content of the accompanying claims, potential equivalents being included therein.

What is claimed is:

1. A data-processing system and integration of payment means operations (100), characterized by comprising
an equipment and services platform (50);
multiple sources of payment means operations (30a, 30b, 30c, 30d);
data processer of payment means operations,
the equipment and services platform (50) receiving multiple data and transactions (3a, 3b, 3c, 3d) from the multiple sources of payment means operations (30a, 30b, 30c, 30d), said multiple data and transactions (3a, 3b, 3c, 3d) being identified and processed individually by the data processer of payment means operations such that each of the multiple sources of payment means operation (30a, 30b, 30c, 30d) receives specific responses (3′a, 3′b, 3′c, 3′d) for their operations.

2. The system according to claim 1, wherein the data processer of payment means operations consists of a computer program that:
(i) identifies the multiple data and transactions (3a, 3b, 3c, 3d) from the multiple sources of payment means operations (30a, 30b, 30c, 30d);
(ii) processes the transactions on the equipment and services platform (50) in at least one data-processing center (56) jointly with a hardware based encryption device (51); and
(iii) provides the specific responses (3′a, 3′b, 3′c, 3′d) for multiple sources of payment means operations (30a, 30b, 30c, 30d).

3. The system according to claim 2, wherein the processing of the transactions on the equipment and services platform (50) in at least one data-processing center (56) jointly with a hardware based encryption device (51) is carried out in a cloud environment.

4. The system according to claim 1, wherein the equipment and services platform (50) comprise Safe Room (52) environments for operations with cryptographic keys and a key ceremonial Module (53).

5. The system according to claim 4, wherein comprises PCI and FIPS-3 certifications, API services and technical support embedded in the equipment and services platform (50).

6. The system according to claim 3, wherein comprises PCI and FIPS-3 certifications, API services and technical support embedded in the equipment and services platform (50).

7. The system according to claim 2, wherein comprises PCI and FIPS-3 certifications, API services and technical support embedded in the equipment and services platform (50).

8. The system according to claim 1, wherein comprises PCI and FIPS-3 certifications, API services and technical support embedded in the equipment and services platform (50).
